(19) United States
(12) Patent Application Publication
(10) Pub. No.: US 2005/0138027 A1
(43) Pub. Date: Jun. 23, 2005

(54) Filtering server, filtering system, and filtering method

(76) Inventor: Yasuhiro Kawakita, Osaka (JP)

Correspondence Address: RABIN & Berdo, PC, 1101 14TH STREET, NW, SUITE 500, WASHINGTON, DC, 20005, US

(21) Appl. No.: 11/012,303

(22) Filed: Dec. 16, 2004

(30) Foreign Application Priority Data
Dec. 17, 2003 (JP) JP2003-419873

(51) Int. Cl. G06F 17/30

(52) U.S. Cl. 707/5

(57) ABSTRACT

In a filtering server which filters specific information desired by an information provider to be recognized by a user depending on a desire of the user and which transmits specific information which is not excluded by the filtering to the user, the specific information desired by the user to be browsed is retrieved on the basis of a keyword input by the user, and, on the basis of a result obtained by checking whether the specific information has been already presented, it is decided whether the specific information is transmitted to the user.

### CROSS REFERENCE TO RELATED APPLICATIONS

The disclosure of Japanese Patent Application No. JP2003-419873, filed Dec. 17, 2003, entitled “Filtering System”. The contents of that application are incorporated herein by reference in their entirety.

### BACKGROUND OF THE INVENTION

1. Field of the Invention

The present invention relates to a filtering server, a filtering system, and a filtering method which filter information to be delivered to a user.

2. Description of the Related Art

In the specification of Japanese Patent Laid-open Publication No. 2003-30527, a technique that provides appropriate information to a user through a communication network is disclosed.

In the technique disclosed in the specification Japanese Patent Laid-open Publication No. 2003-30527, a user (demander) inputs a bar code attached to a commercial product or a service to make it possible to obtain information related to the commercial product or the service. In this case, information which can be obtained is information associated with the bar code.

On the other hand, some search site actually managed has an insertion system which inserts an advertisement linked to a keyword.

In the advertisement insertion system, an object to be retrieved is a Web page on the internet. An information provider who intends to place an advertisement on a page serving as a retrieval result enters the search site as a sponsor.

When a user who operates a Web browser inputs a keyword, location data (URL) of a Web page which is matched with the keyword and a part of the content of the Web page are displayed as a list.

When the keyword is matched with sponsor information, it is clearly specified that the information is sponsor information, and the information is displayed on the screen of the Web browser as a part of a retrieval result. The sponsor information includes a sponsor name, a URL, or an outline of a Web page designated by the URL.

The search site obtains a charge from the sponsor company as a price for displaying the sponsor information on a browser screen together with a retrieval result.

### SUMMARY OF THE INVENTION

In the advertisement insertion system disclosed above, each time a keyword is matched with sponsor information, the sponsor information must be repetitively displayed on a browser screen. In addition, when the same uninteresting sponsor information is displayed on the screen again and again, the sponsor information is disliked by a user. In addition, consequently, the user rarely read the sponsor information to deteriorate the advertising effectiveness.

On the other hand, in the technique described in the specification of Japanese Patent Laid-open Publication No. 2003-30527, a user changes demander desired information or a demander notification condition in advance to make it possible to change available information. However, the demander desired information or the demander notification condition is changed to increase an operation load on a user. As a result, the usability is deteriorated.

In order to solve the above problem, according to an aspect of the present invention, there is provided a filtering server which filters specific information desired by an information provider to be recognized by a user depending on a desire of the user and which transmits specific information which is not excluded by the filtering to the user, including: a keyword acquiring section for acquiring a keyword input by the user; a specific information accumulating section for accumulating a plurality of pieces of specific information; a specific information retrieving section for retrieving specific information desired to be browsed by the user from the specific information accumulating section on the basis of the keyword acquired by the keyword acquiring section; a specific information presentation recording section for storing the specific information retrieved by the specific information retrieving section and a recording information of the specific information; a specific information presentation control section for extracting at least one piece of specific information from the pieces of specific information stored in the specific information presentation recording section depending on the recording information of the specific information presentation recording section; and a specific information presentation section for presenting the specific information extracted by the specific information presentation control section to the user.

The recording information may be presentation status information representing a status in which the specific information has been presented to the user until now, and the specific information presentation control section can extract only specific information which has not been presented to the user until now.

The recording information may be content updating information representing whether the specific information is updated after the specific information is previously presented to the user and whether the specific information has been presented to the user until now, and the specific information presentation control section can extract only the updated specific information and specific information which has not being presented to the user until now.

The filtering server may be further comprising a setting screen presentation section for collecting specific information desired by a user through a setting Web page, a difference acquiring section for acquiring a Web page at regular or irregular intervals on the basis of an input content collected by the setting screen presentation section, and extracting a difference between the Web page and a previously acquired Web page; and an updating information presentation section for presenting the difference extracted by the difference extracting section to the user.

In order to solve the above problem, according to another aspect of the present invention, there is provided a filtering system which includes a communication terminal used by a user and also includes a filtering server which is connected to the communication terminal through a communication network and which filters specific information desired by an information provider to be recognized by the user depending on a desire of the user and which transmits specific information which is not excluded by the filtering to the user, wherein the communication terminal includes: an input section for inputting a keyword; and an output section for outputting a result obtained by the filtering, and the filtering server includes: a keyword acquiring section for acquiring a keyword input by the user via the communication terminal; a specific information accumulating section for accumulating a plurality of pieces of specific information; a specific information retrieving section for retrieving specific information desired to be browsed by the user from the specific information accumulating section on the basis of the keyword acquired by the keyword acquiring section; a specific information presentation recording section for storing the specific information retrieved by the specific information retrieving section and a recording information of the specific information; a specific information presentation control section for extracting at least one piece of specific information from the pieces of specific information stored in the specific information presentation recording section depending on the recording information of the specific information presentation recording section; and a specific information presentation section for presenting the specific information extracted by the specific information presentation control section to the output section.

In order to solve the above problem, according to still another aspect of the present invention, there is provided a filtering method which filters specific information desired by an information provider to be recognized by a user depending on a desire of the user and which transmits specific information which is not excluded by the filtering to the user, including: the keyword acquiring step of acquiring a keyword input by the user; the specific information retrieving step of retrieving specific information desired to be browsed by the user on the basis of the keyword acquired by the keyword acquiring step; the specific information presentation recording step of storing the specific information retrieved in the specific information retrieving step and a recording information of the specific information; a specific information presentation control step for extracting at least one piece of specific information from the specific information retrieved in the specific information retrieving step depending on the recording information of the specific information retrieved in the specific information retrieving step; and the specific information presentation step of presenting the specific information extracted in the specific information presentation control step to the user.

According to the present invention, a filtering system having high usability and high flexibility can be provided without excessively loading on a user. Furthermore, when specific information includes, e.g., an advertisement, advertising effectiveness can be improved.

### BRIEF DESCRIPTION OF THE DRAWINGS

FIG. 1 is a schematic diagram showing the entire configuration of a filtering system.

FIG. 2 is a schematic diagram showing the configuration of a filtering server according to a first embodiment.

FIG. 3 is a schematic diagram showing a configuration of a user attribute information accumulating section.

FIG. 4 is a table showing data with which user attribute information and keywords are associated in advance.

FIG. 5 is a table showing a list of specific information accumulated in a specific information accumulating section.

FIG. 6 is a table showing a list of specific information with which keywords are associated.

FIG. 7 is a diagram showing presentation state information stored in a specific information presentation recording section.

FIG. 8 is a schematic diagram showing a configuration of a Web page returned as a response.

FIG. 9 is a schematic diagram showing the configuration of a filtering server according to a second embodiment.

FIG. 10 is a diagram showing content updating information stored in a specific information presentation recording section.

FIG. 11 is a diagram showing data stored in the specific information presentation recording section.

FIG. 12 is a schematic diagram showing the configuration of a filtering server according to a third embodiment.

FIG. 13 is a schematic diagram showing a configuration of a setting screen.

FIG. 14 is a schematic diagram showing an example of accumulated contents of a difference acquiring section.

FIG. 15 is a schematic diagram showing a configuration of a Web page returned as a response.

### DETAILED DESCRIPTION OF THE PREFERRED EMBODIMENTS

Preferred embodiments of the present invention will be described below with reference to the accompanying drawings. In this specification and the drawings, the same reference numerals denote components substantially having the same functions, respectively, and overlapping descriptions will not be repeated here.

Filtering systems according to the embodiments will be described below such that the filtering systems are applied to a communication system connected through a communication network.

### First Embodiment: Filtering System

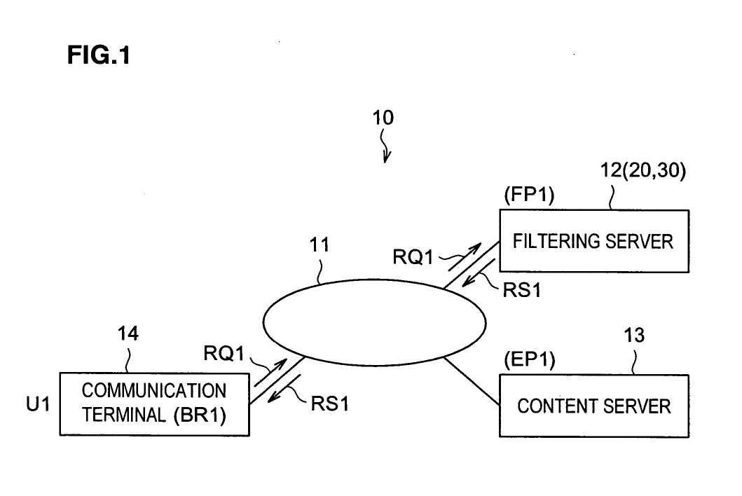

FIG. 1 is a schematic diagram showing the entire configuration of a filtering system 10 according to the embodiment.

In FIG. 1, the filtering system 10 includes a network 11, a filtering server 12, a content server 13, and a communication terminal 14.

The network 11 is a communication network such as a LAN (local area network) or the internet. In the embodiment, the network 11 is the internet.

The filtering server 12 and the content server 13 are Web servers, respectively. The content server 13 is a usual Web server managed by a sponsor serving as the information provider (in this case, called an EP1). The filtering server 12 is a component corresponding to the search site, and is a Web server serving as a characteristic feature of the embodiment. It is assumed that the filtering server 12 is managed by a carrier FP1.

The communication terminal 14 is a communication terminal on which a Web browser BR1 serving as a client function for the Web server is mounted, and is operated by a user U1. The communication terminal may be, e.g., a personal computer.

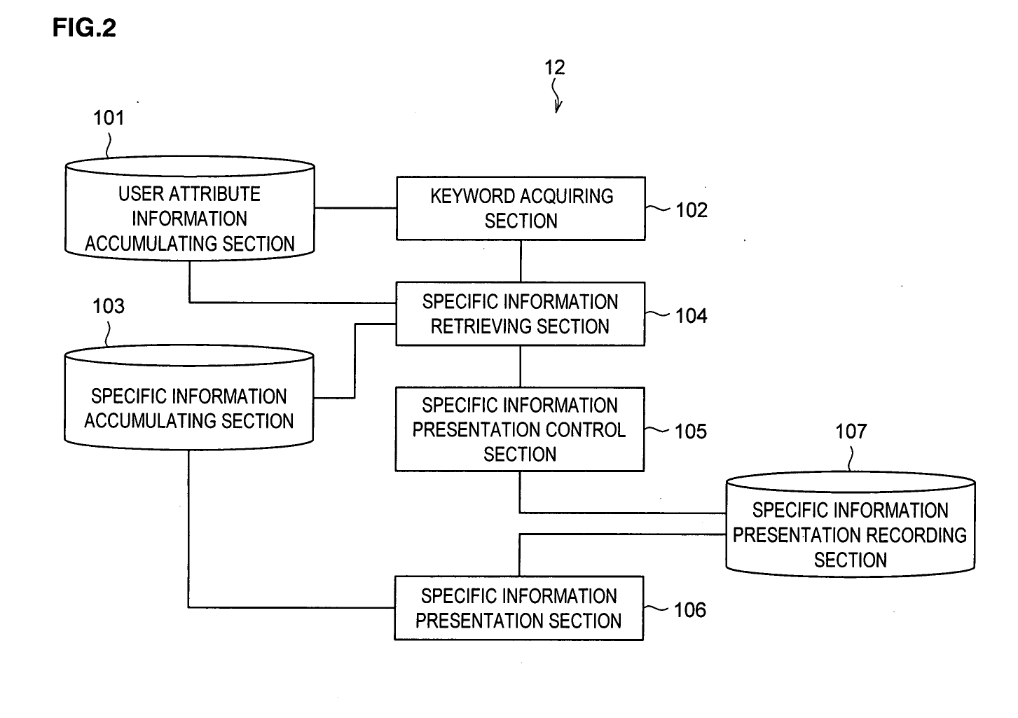

FIG. 2 is a schematic diagram showing the configuration of the filtering server 12 serving as a Web server.

In FIG. 2, the filtering server 12 includes a user attribute information accumulating section 101, a keyword acquiring section 102, a specific information accumulating section 103, a specific information retrieving section 104, a specific information presentation control section 105, a specific information presentation section 106, and a specific information presentation recording section 107.

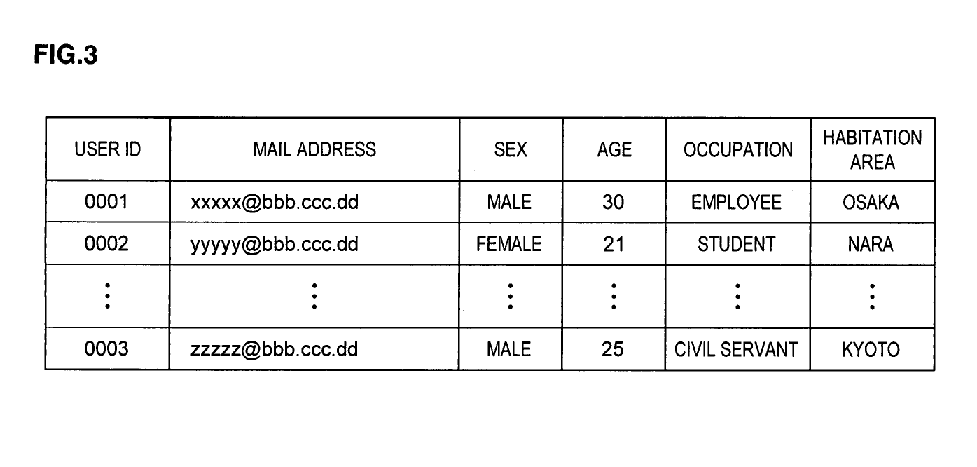

The user attribute information accumulating section 101 stores attribute information of a user (for example, U1). The attribute information includes at least information which can uniquely specify a user in the filtering server 12. The information which can uniquely specify the user is, e.g., a user ID allocated to each user in the filtering server 12. The attribute information may also include sex, age, occupation, habitation area, mail address, and the like acquired from the user. In this case, the data accumulated in the user attribute information accumulating section 101 is as shown in FIG. 3. In FIG. 3, the user ID, the mail address, the sex, the age, the occupation, and the habitation area are associated with each other.

The keyword acquiring section 102 acquires a keyword input by the user U1 and associates the keyword with the user U1. An input screen is transmitted from the filtering server 12 to the communication terminal 14 as a Web page on which a keyword can be input. The user U1 inputs a keyword through the input screen.

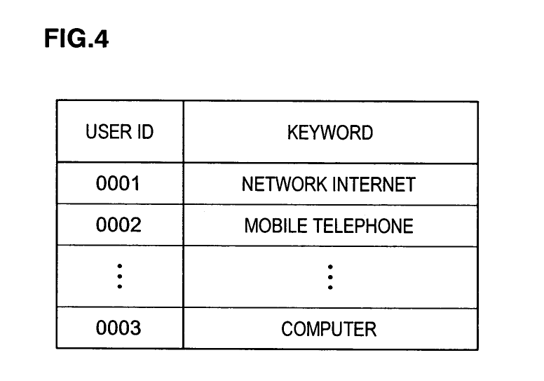

The keyword acquiring section 102 may acquire a keyword depending on the user U1 with reference to data with which user attribute information and a keyword are associated. FIG. 4 is an example of a table showing these data. As the user attribute information, the user ID is used.

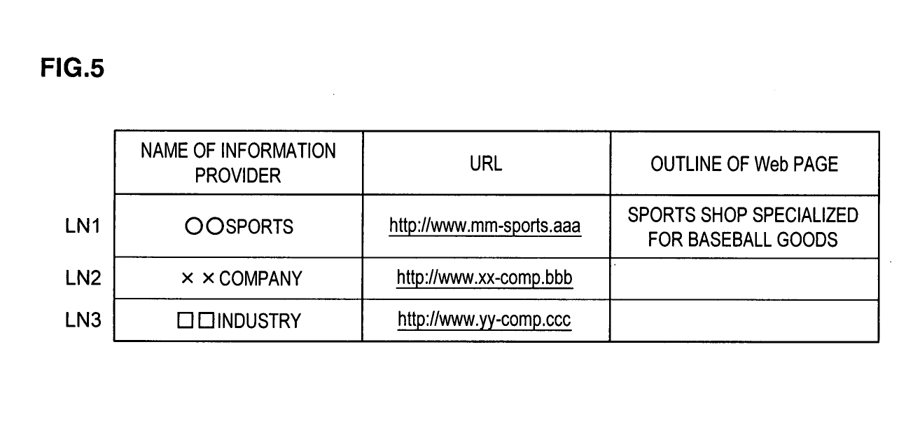

The specific information accumulating section 103 accumulates specific information to be presented by an information provider (e.g., EP1) to a user. The specific information includes the name of an information provider presented to the user, the URL of a Web page provided by the information provider, the outline of the Web page, and the like. In this manner, the specific information include various pieces of information corresponding to the sponsor information. FIG. 5 is a table showing a list of specific information accumulated in the specific information accumulating section 103. In this case, the name of an information provider, a URL, and an outline of a Web page are cited as examples. The specific information accumulating section 103 accumulates the contents of the Web pages themselves as needed.

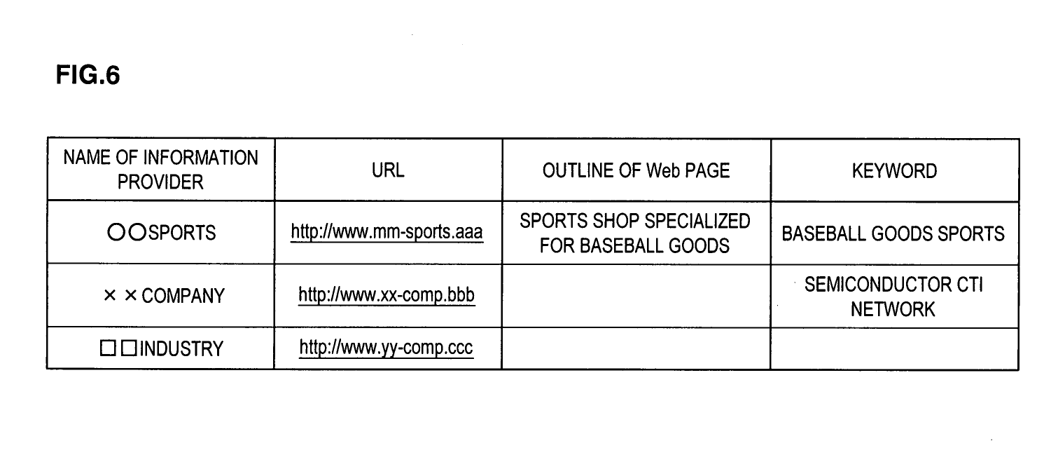

The specific information accumulating section 103 may extract keywords included in pieces of specific information in advance and accumulates the keywords with association with the pieces of specific information. FIG. 6 is a table showing a list of the pieces of specific information with which the keywords are associated. In this case, the name of an information provider, a URL, and an outline of a Web page serving as the pieces of specific information are associated with keywords. With the configuration, specific information can be easily retrieved by a keyword input by the user.

The specific information retrieving section 104 retrieves specific information on the basis of a keyword acquired by the keyword acquiring section 102. An object to be retrieved is basically a Web page corresponding to a URL or an outline of the Web page in the specific information accumulated in the specific information accumulating section 103. As needed, a retrieval range is limited to the outline of the Web page to reduce a processing load on the filtering server 12 and improve response capability.

When the number of users who use the filtering server 12 increases, the information provider can more effectively notify the users of the specific information. Therefore, the accumulated contents of the specific information accumulating section 103 becomes abundant, and the specific information matched with the keyword input by the user is not easily absent in the specific information accumulating section 103.

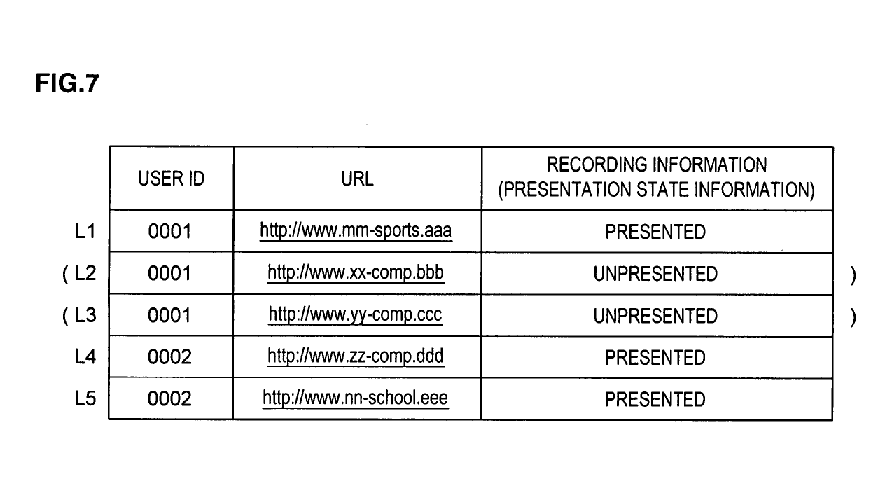

The specific information presentation recording section 107 records a recording information. In the embodiment, the recording information is presentation status information representing a status in which specific information has been presented to a user until now. As the recording information (presentation status information) of the embodiment, information representing whether the specific information is presented or unpresented to the user is recorded. Data stored in the specific information presentation recording section 107 is as shown in FIG. 7. As shown in FIG. 7, a presented record is left because the specific information as the presented specific information is prevented from being repetitively presented to the user U1. In addition, as in L2 and L3 of the presentation status information, values are extemporaneously unpresented with passing time. Normally, only presented values are displayed.

The specific information presentation control section 105 controls whether the specific information is presented on the basis of the presentation status information recorded on the specific information presentation recording section 107. Basically, on the basis of the record representing whether the specific information is presented, the specific information which has been presented is not presented. However, when the user U1 operates a hyperlink (URL) in a Web page corresponding to the specific information to access a new Web page to another link (URL destination) in past presentation, the specific information can be presented again even though the specific information has been presented. In this case, the access to the new Web page must be recorded in the specific information presentation recording section 107 as a part of the presentation status information.

The specific information presentation section 106 executes presentation of specific information under the control of the specific information presentation control section 105. More specifically, under the control of the specific information presentation control section 105, Web pages to be presented are generated to users (one of the users is the user U1), respectively, and the Web pages are returned to the users as a part of an HTTP response message.

### Operation of First Embodiment

An operation of the embodiment having the above configuration will be described below.

It is assumed that the user U1 accesses the filtering server 12 through the Web browser BR1 and that the user ID of the user U1 corresponds to “0001” shown in FIGS. 3, 4, and 7.

As is apparent from FIG. 7, the user ID is “0001” in three lines L1 to L3. The specific information (also including a URL itself) designated by a URL (in this case, http://www.mm-sports.aaa) corresponding to the uppermost line (i.e., the line L1) in FIG. 7 has been presented. The specific information corresponding to the URL of the line L2 serving as the second upper line is not presented. The specific information corresponding to the URL of the line L3 serving as the third upper line is not presented. However, when an HTTP request message from the user U1 is received, it is assumed that the lines L2 and L3 in FIG. 7 are not present and that the presentation status information is constituted by only a presented line in FIG. 7.

In this state, it is assumed that the user U1 accesses the filtering server 12 through the Web browser BR1 of the communication terminal 14 and transmits a keyword through the input screen. The keyword is delivered from the Web browser BR1 (communication terminal 14) to the filtering server 12 as a part of an HTTP request message RQ1. The keyword included in the HTTP request message RQ1 is acquired by the keyword acquiring section 102.

At this time, the filtering server 12 must specify a user who accesses to the filtering server 12 by some method as the user U1. The user can be specified by various methods. For example, when the filtering server 12 provides a members-only service, the filtering server 12 can specify a user by causing the user to declare a member ID. Furthermore, a user can also be specified by using cookies or the like. When a user can specified as the user U1, it can be understood that the user ID of the user is the “0001”.

The specific information retrieving section 104 retrieves specific information, e.g., an outline of a Web page or the Web page itself, serving as an accumulated content of the specific information accumulating section 103 on the basis of the keyword input by the user. The specific information retrieving section 104 collects the outline of the Web page matched with the keyword and the URL of the Web page by, e.g., a method shown in FIG. 5. At this time, for example, as shown in FIG. 6, a keyword extracted from the outline of the Web page is extracted in advance and registered in the specific information accumulating section 103 in association with each URL to make it easy to retrieve the outline of the Web page.

The accumulated contents of the specific information accumulating section 103 are abundant, the number of outlines of Web pages including a character string matched with the keyword or the number of Web pages increases, and the number of collected URLs also increases. Therefore, a set of URLs (URL set) including a large number of URLs as elements is formed. In this case, a URL set S1 including n URLs (URL1, URL2, . . . , URLn) as elements is formed. The specific information presentation control section 105 acquires the URL set S1 and “0001” serving as the user ID.

The specific information presentation control section 105 specifies a line corresponding to the user ID in lines L1, L4, and L5 in the specific information presentation recording section 107 (there are no lines L2 and L3 at this time). When the data stored in the specific information presentation recording section 107 is obtained by removing the lines L2 and L3 from the lines in FIG. 7, only the line L1 in FIG. 7 corresponds to the user ID “0001” (i.e., the user U1).

The specific information presentation control section 105 compares the URLs serving as the elements of the URL set S1 with the URL of the line L1, and adds at least one line corresponding to at least one element which is not matched with the URL of the line L1 to the specific information presentation recording section 107. In this case, the user ID of the line to be added is “0001”, the value of the URL is the URL itself, and the value of the presentation status information is “unpresented”.

In the embodiment, the URLs corresponding to the two lines L2 and L3 are added, and the data stored in the specific information presentation recording section 107 has a state shown in FIG. 7.

When a plurality of keywords transmitted through the HTTP request message RQ1, the same process is repeatedly executed. Each the process is executed, a new line can be added as described above. In the embodiment, for descriptive convenience, only one keyword is included in the HTTP request message RQ1, and only the lines L2 and L3 are added.

Upon completion of the addition of the lines to the HTTP request message RQ1, the specific information presentation control section 105 gives a control right to the specific information presentation section 106. The specific information presentation section 106 extracts the URLs corresponding to the two lines L2 and L3 in which the values of presentation state information are unpresented in the data (in FIG. 7) in the specific information presentation recording section 107 and acquires the name and/or URL of an information provider designated by the URL and/or the outline of a Web page from the specific information accumulating section 103. However, in this case, only the name and URL of the information provider are acquired.

As is apparent of comparison between the URLs included in FIGS. 5 and 7, the line corresponding to the URL of the line L2 in FIG. 7 is a line LN2 in FIG. 5, and the line corresponding to the URL of the line L3 in FIG. 7 is a line LN3 in FIG. 5. Therefore, “xx company” and “□□ industry” are acquired as the names of information providers, and “http://www.xx-comp.bbb” and “http://www.yy-comp.ccc” are acquired as URLs.

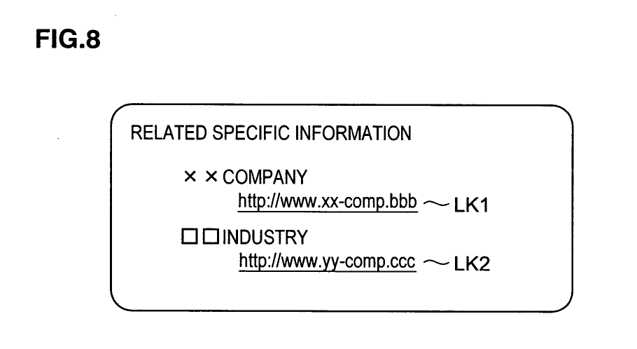

The specific information presentation section 106 generates a Web page as shown in, e.g., FIG. 8 on the basis of the acquired pieces of information and returns the Web page to the Web browser BR1 as a part of an HTTP response message RS1. The HTTP response message RS1 is a response to the HTTP request message RQ1 described above.

The Web browser BR1 of the communication terminal 14 which receives the HTTP response message RS1 displays a Web page shown in FIG. 8 on a screen. Therefore, the user U1 can visually check the screen. Since displays LK1 and LK2 of the URLs displayed in FIG. 8 are hyperlinks, the user U1 who operates the communication terminal 14 clicks the hyperlink to acquire a linked Web page, and can browse the Web page.

### Effect of First Embodiment

According to the embodiment, since a Web page in which a browsing history of each of users (one of the users is the user U1) can be returned to the user, even though time the user inputs the same keyword, specific information (e.g., the name of an information provider, a URL, the outline of a Web page, and the like) to be browsed on Web pages changes each time, and a trouble of viewing the same specific information a number of times can be eliminated. Therefore, the filtering server of the embodiment has the usability and the flexibility.

With the configuration, the user can always view new specific information, and can easily find specific information related to information in which the user is interested. Therefore, the user can easily reach desired information.

This also contributes to improvement in advertising effect when specific information is an advertisement or the like.

### Second Embodiment: Filtering System

Only points of difference between the second embodiment and the first embodiment will be described below.

The embodiment is different from the first embodiment in that the recording information of the specific information presentation recording section 107 is content updating information but presentation state information.

For example, the content updating information is recording information representing whether the content of the Web page corresponding to the specific information is updated from time when the specific information is presented to the previous user (e.g., u1), i.e., information representing whether the content is a new content for the user.

Functions other than the function related to the content updating information of the embodiment are the same as those in the first embodiment.

### Configuration and Operation of Second Embodiment

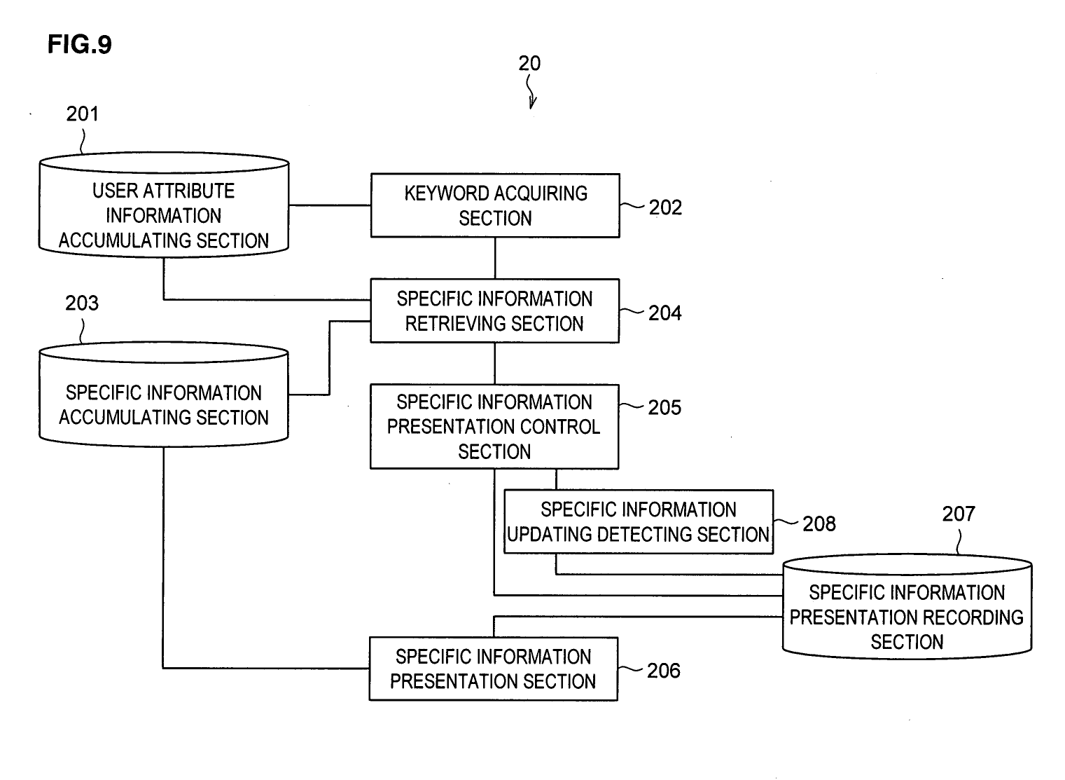

FIG. 9 is a schematic diagram showing the configuration of a filtering server 20 according to the embodiment.

In FIG. 9, since the functions of components 201 to 207 to which the same names as those in FIG. 1 are given the same as those in the first embodiment, and a description thereof will not be repeated here.

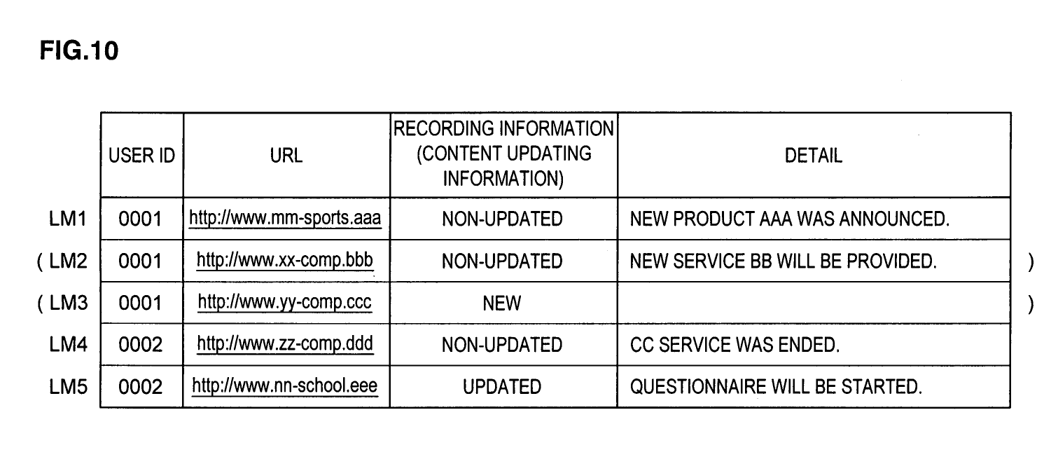

Data stored in a specific information presentation recording section 207 is as shown in, e.g., FIG. 10. The specific information presentation recording section 207 is different from the specific information presentation recording section 107 according to the first embodiment in that the specific information presentation recording section 207 records, as recording information, the content updating information, i.e., “unupdated”, “updated”, and “new”.

In this case, “unupdated” means that the content of a Web page is not updated from time when the content is previously presented to the user (e.g., a user U1). “Updated” means that the content of a Web page is updated from time when the content is previously presented to the user (e.g., the user U1). “New” means that a Web page is a new Web page which never be presented to the user (e.g., the user U1).

A specific information updating detecting section 208 serving as a component of the filtering server 20 according to the embodiment acquires these pieces of content updating information related to the Web page corresponding to specific information. The content updating information may be acquired from HTTP control information by using a HEAD method or the like. However, in this case, the content (body of the content) of the Web page is acquired and compared with the content of the Web page which is previously acquired to check whether the contents are different from each other, thereby acquiring the contents updating information. A method of checking whether the body of the content is different from that of the content of the previously acquired Web page heavily loads the processing ability of the filtering server 20 in comparison with a method using HTTP control information. However, although the detail of the body of a content is not updated, the specific information updating detecting section 208 can prevent from erroneously determine that the detail is updated when only the time stamp of the content is updated. Therefore, more accurate and exact information can be advantageously obtained.

When the user U1 uses the filtering server 20, data which has been stored in the specific information presentation recording section 207 includes a line corresponding to the user U1. FIG. 10 is a diagram showing content updating information stored in the specific information presentation recording section 207. In this case, user ID “0001” correspond to three lines LM1 to LM3.

The specific information updating detecting section 208 updates a recorded content in the specific information presentation recording section 207 into a new content by automatic processes even though any request is not received from the user U1. The processes may be executed at regular or irregular intervals.

For example, in the line LM1, the filtering server 20 transmits an HTTP request message to “http://www.mm-sports.aaa” to make it possible to acquire a content body. However, the filtering server 20 itself has a function of content server (i.e., a function of a Web server of some content provider), the filtering server 20 accesses a file managed by the filtering server 20 itself to acquire the content body.

The filtering server 20 transmits an HTTP request message to the “http://www.mm-sports.aaa” and receives an HTTP response message serving as a response of the HTTP request message from the content server 13. Thereafter, the specific information updating detecting section 208 compares the body of the latest content included in the HTTP response message with a content body previously acquired and accumulated in a specific information accumulating section 203 or the like to check whether the previously acquired content is replaced with the latest content.

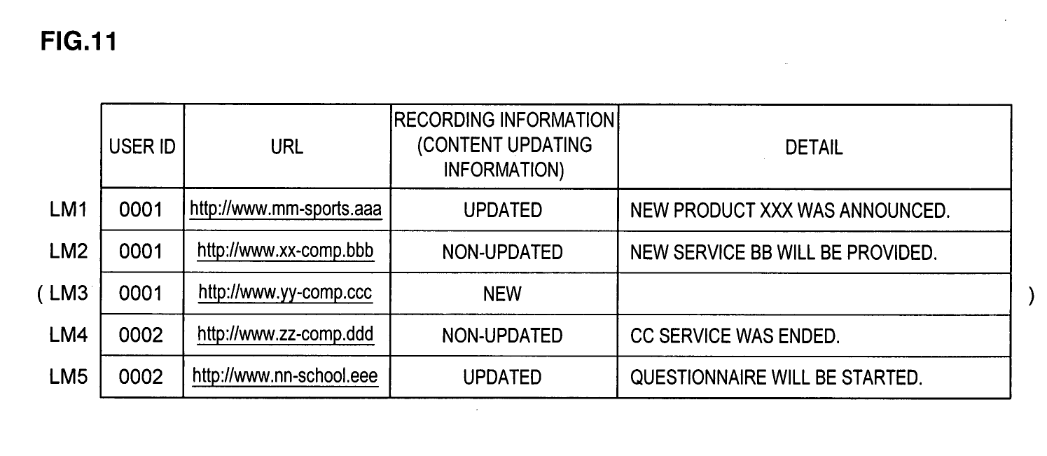

When it is determined in the check that the content is not updated, with respect to a corresponding line (in this case, the line LM1) of the data stored in the specific information presentation recording section 207, the value of the content updating information is kept at the previous value, e.g., “unupdated”. When it is determined that the content is updated, the value of the content updating information is changed into “updated”. For example, FIG. 11 shows data stored in the specific information presentation recording section 207 and obtained a period of time after the time set in FIG. 10. As is apparent from comparison between FIG. 11 and FIG. 10, the value of the content updating information of the line LM1 is changed from “unupdated” to “updated”. This change reflects that a character string “New product AAA was announced.” in the content body is changed into a character string “New product xxx was announced.”.

When it is determined that the content is not updated, the value of the content updating information of the corresponding row (in this case, the line LM1) is kept at the previous value. This is because “updated” obtained as a result of the previous check since the check is repeated at regular or irregular intervals. Therefore, with respect to a line in which “updated” is recorded in the content updating information as the result of the previous check, the record “updated” is kept after the latest check until the content of the Web page is presented to the user.

Of the values of the content updating information, an order of processes in which “new” is recorded will be described below. A keyword acquiring section 202 corresponding to the keyword acquiring section 102 in the first embodiment acquires a keyword delivered by an HTTP request message RQ1. A specific information retrieving section 204 corresponding to the specific information retrieving section 104 according to the first embodiment retrieves an accumulated content of a specific information accumulating section 203 corresponding to the specific information accumulating section 103 in the first embodiment on the basis of the keyword to obtain a URL set S1. The processes performed until now are the same as those in the first embodiment.

When data stored in the specific information presentation recording section 207 when the HTTP request message RQ1 is delivered from the user U1 does not include a line LM3 in FIG. 10, and when the elements of the URL set S1 include the URL of the line LM3, the line LM3 in which the value of the content updating information in the data of the specific information presentation recording section 207 is “new” is added.

Therefore, the meaning of “new” in the embodiment is equal to “unpresented” in the first embodiment, and is handled like “unpresented” in the first embodiment.

More specifically, specific information in which the content updating information is “new” is presented to the user U1. In the embodiment, specific information in which the content updating information is “updated” is also presented to the user U1.

More specifically, the specific information presentation section 206 generate the Web page of similar FIG. 8 including specific information in which the content updating information corresponds to “new” or “updated”. The Web page is returned to the user U1 as a part of the HTTP response message RS1 serving as a response of the HTTP request message RQ1.

Together with the display LK1 or LK2 shown in FIG. 8, information representing the content updating information of the specific information denoted by the display is “new” or “updated” may be shown to the user U1.

In the specific information updating detecting section 208, content bodies are compared with each other to make it possible to specify an exact updated content. For this reason, the updated content can also be added to the Web page.

For example, the number of characters in which the old and new content bodies are different from each other, a new word with which a specific word (complex word, sentence, or the like) in the old content is replaced, or the like may be simply displayed on the Web page. As the outline of the Web page, a part the content of which is changed by the updating may be displayed.

Even though the content body is updated, when the detail of the content body is not substantially changed, e.g., when wrong letters or missing characters are corrected, the updating is understood as not so much significant updating for a normal user. For this reason, the significance of updating is decided, and the updating is processed as “updated” only when it is understood that the updating is significant.

The decision of the significant of updating may also use natural language processing. For example, it can be decided whether updating is significant or not by checking whether a content to be updated include a specific character string.

For this reason, for example, a rule for deciding a quantity or content of a change such as a change of only date information or a change of characters the number of which is equal or smaller than a predetermined number is set. When a condition is matched with the rule, processing which does not decide the change as updating can also be performed.

### Effect of Second Embodiment

According to the embodiment, an effect which is approximately equivalent to the effect of the first embodiment can be obtained.

In addition, in the embodiment, when specific information corresponding to an unupdated content is not presented to a user, and when the detail of a content body is changed by updating, specific information corresponding to the content is presented to the user. Therefore, when the user inputs only the same keyword, the user can know fresh specific information related to the keyword.

A user need not browse Unchanged specific information. This regard considerably contributes to a reduction in load on the user.

### Third Embodiment: Filtering System

A difference between this embodiment and the first and second embodiments will be described below.

A characteristic feature of the embodiment, the presence of updating is checked with respect to at least one Web page designated by a URL input by a user (U1) himself such that the user (U1) uses a predetermined setting screen, thereby notifying the user of the presence of updating.

Functions other than the function related to the setting screen in the embodiment are the same as those in the second embodiment.

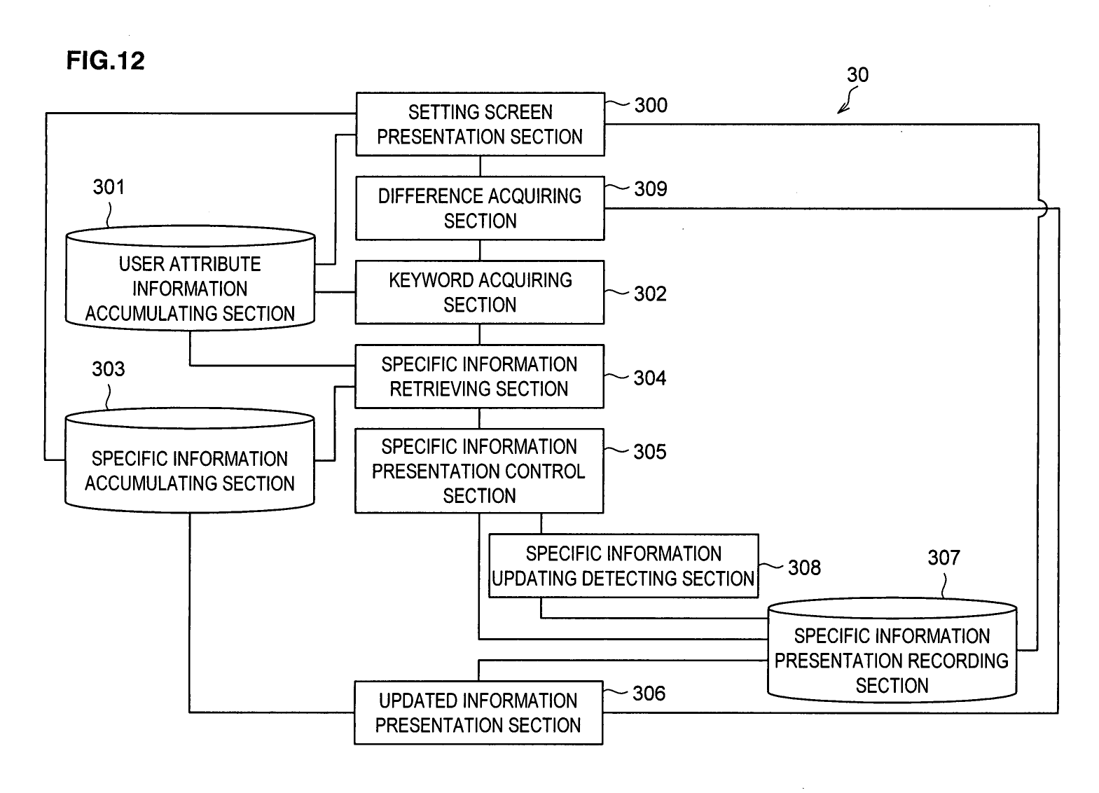

Since the embodiment includes a specific information updating detecting section 308 (refer to FIG. 12), it is understood that the embodiment is closer to the second embodiment than the first embodiment.

### Configuration and Operation of Third Embodiment)

FIG. 12 is a schematic diagram showing the configuration of a filtering server 30 according to the embodiment.

In FIG. 2, since the functions of components 302 to 305, 307, and 308 to which the same names as those in FIG. 9 are added are basically the same as the functions in the second embodiment, a description thereof will not be repeated here.

As other components, the filtering server 30 includes a setting screen presentation section 300, an updated information presentation section 306, and a difference acquiring section 309 shown in FIG. 12.

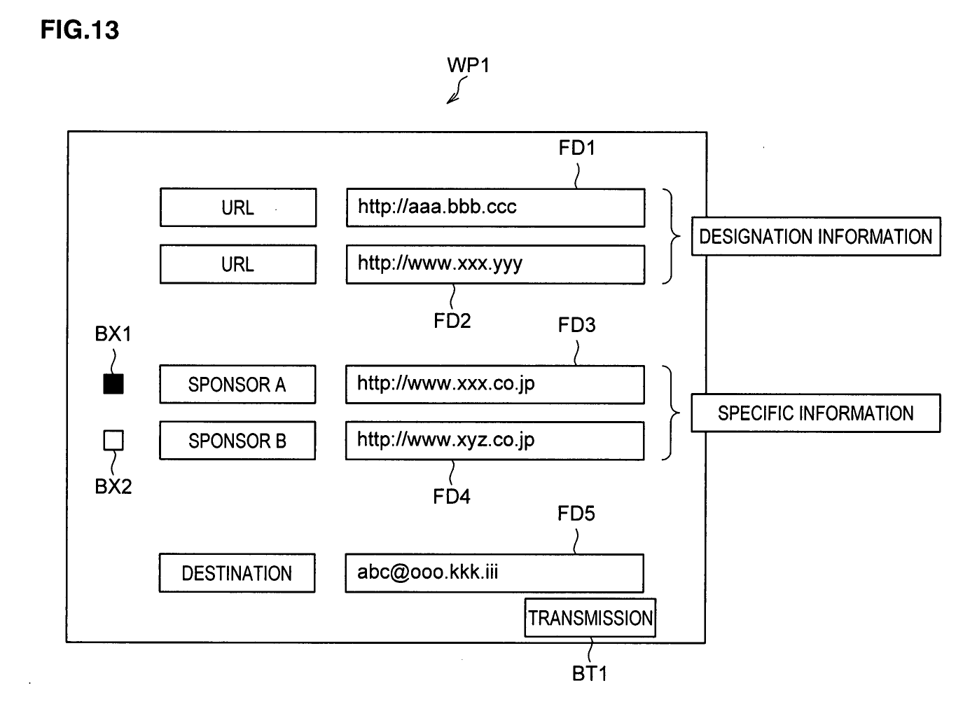

The setting screen presentation section 300 generates a setting screen (Web page for setting) WP1 as shown in, e.g., FIG. 13 and provides the setting screen WP1 to a Web browser BR1 of the user U1. The user directly inputs a URL or the like in the setting Web page WP1. The setting screen presentation section 300 uses a device having the above form to collect input contents of the user U1.

In FIG. 13, the user U1 operates the communication terminal 14 to make it possible to input fields FD1, FD2, and FD5 and click boxes BX1 and BX2 on the Web browser BR1.

The fields FD1 and FD2 of these fields are URL input fields for dynamically describing the URLs of Web sites in which the user U1 is interested when the user U1 inputs the fields.

The URLs of fields FD3 and FD4 are URLs of specific information accumulated in the filtering server 30.

The click boxes BX1 and BX2 are boxes which are clicked by the user U1 on the communication terminal 14 to select desired specific information. In this case, a plurality of pieces of specific information can be simultaneously selected, or only one piece of specific information can be selected. It is naturally possible that any specific information is not selected.

The field FD5 is a field in which an address to which the filtering server 30 notices a result obtained by checking the presence of updating related to a Web page designated by the user U1 through selection of the fields FD1 and FD2 or the click boxes BX1 and BX2. In an example in FIG. 13, an electronic mail address of the user U1 is described. A check result can be returned as an HTTP response message. This check may requires an access to another Web server (for example, the content server 13 in FIG. 1). An electronic mail is used in the example in FIG. 13 to prevent response time from being excessively long. This electronic mail may be a so-called mail magazine obtained by collecting, e.g., the contents of an updated Web page.

The user U1 operates a “transmission” button BT1 upon completion of inputting to the respective sections of the setting Web page WP1. In this manner, the input content is transmitted to the filtering server 30 as an HTTP request message.

An operation procedure in the embodiment performed on the assumption that the setting Web page WP1 is acquired by the user U1 is different from an operation procedure in the embodiment performed when subsequent processes are performed without passing through the setting Web page WP1. Therefore, the configurations of Web pages (also including a Web page (not shown)) presented by the filtering server 30 to the user U1 are different from each other. A case in which the subsequent processes are started through the setting Web page WP1 is described here.

It is assumed that the subsequent processes are executed through only the setting Web page WP1. In this case, when the user U1 views the setting Web page WP1 for the first time, as a matter of course, the user U1 also uses the filtering server 30 for the first time, and any information related to the user U1 is not accumulated in the specific information presentation recording section 307 and the specific information accumulating section 303.

In this case, on an initialized setting Web page WP1 transmitted from the filtering server 30 and displayed on the browser screen of the communication terminal 14, all the fields FD1 to FD5 and the click boxes BX1 and BX2 are blank.

On the setting Web page WP1 in this state, the user U1 can input only the fields FD1, FD2, and FD5.

The number of input fields of the setting Web page WP1 is not limited to the number of items shown in FIG. 13. In addition, fields for inputting keywords can also be arranged for designation information and specific information.

When the user U1 browses the setting Web page WP1 again, the specific information accumulating section 303 and the specific information presentation recording section 307 have included lines corresponding to the user U1. For this reason, even on the setting Web page WP1 which has been provided just now, URLs have been input in the fields FD1 to FD4, respectively. The setting screen presentation section 300 directly performs this input process. The accumulated content of the specific information accumulating section 303 is reflected in the input content.

For example, when the setting screen presentation section 300 generates the second setting Web page WP1 for the user U1, the URL input by the user U1 in the first presentation may be described in the fields FD1 and FD2 on the setting Web page WP1 each, and the URL of specific information matched with a keyword included in the Web page designated by the URL input by the user U1 may be described in the fields FD3 and FD4 each.

Even in the second and subsequent browsing operations, all the fields FD1 to FD5 may not be filled.

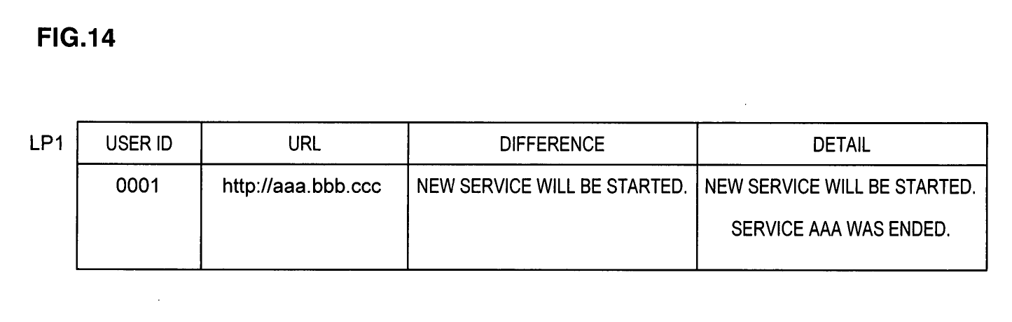

The difference acquiring section 309 acquires a Web page at regular or irregular intervals on the basis of the input content (for example, URL) collected by the setting screen presentation section 300, extracts a difference between the previously acquired Web page and the Web page acquired at the present, and accumulates the difference. This difference may be accumulated in association with at least a user ID and a URL, and may also be accumulated in association with the content of the acquired Web page as needed. When the entire content of the Web page is also accumulated in association with the difference, the configuration of the data accumulated in the difference acquiring section 309 is shown in FIG. 14.

A keyword acquiring section 302 extracts a character string corresponding to a keyword from the difference acquired in the difference acquiring section 309. The method of extracting a keyword is not specifically determined. A conventional technique is applied as the method. The keyword acquiring section 302 is desirably interlocked with the difference acquiring section 309. This is because, when the difference acquiring section 309 completely records a series of pieces of information, the keyword acquiring section 302 can effectively start acquisition of a keyword.

When not only the difference acquired by the difference acquiring section 309 but also the entire content of the Web page as shown in FIG. 14 are accumulated, the keyword acquiring section 302 may extract a character string corresponding to a keyword from the entire content of the Web page. In any case, the method of extracting a keyword from the acquired information or the difference is not specified. However, a technique which handles a title portion as a keyword, a technique which handles, as a keyword, a character string frequently appearing in specific character strings included in a document to be acquired, or a technique which handles, as a keyword, a word determined as a noun after syntactic analysis, or the like is applied to make it possible to acquire a keyword.

The updated information presentation section 306 specifies a line (for example, a line LP1 in FIG. 14) corresponding to a URL indicated by information (input contents in the fields FD1 to FD4 and the click boxes BX1 and BX2) collected from the setting screen presentation section 300 and presents the difference and the URL included in the line to the user U1.

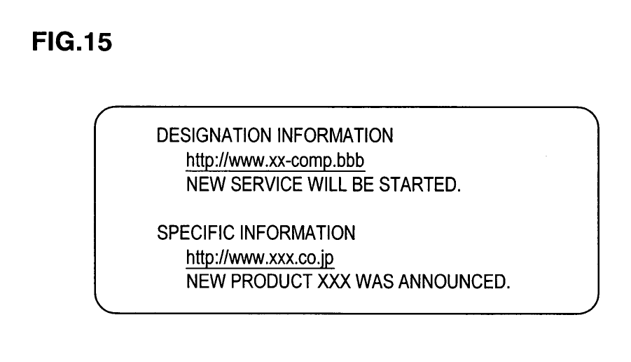

When the electronic mail is used in this presentation, the filtering server 30 transmits an electronic mail having a text portion shown in, e.g., FIG. 15 to an electronic mail address designated by the user U1 in the field FD5.

### Effect of Third Embodiment

According to the embodiment, an effect which is approximately equivalent to the effect of the second embodiment can be obtained.

In addition, in the embodiment, only when the content of the Web page designated by the user (U1), the filtering server 30 notifies the user of the content of the updating. For this reason, the user can efficiently know updating of a Web page in which the user is interested.

When an information provider (for example, EP1) merely updates the content of a Web page, the information provider can advantageously notify a user (for example, U1) who is interested in the content of the Web page of the updated content.

A carrier FP1 who manages the filtering server 30 can charge an information provider on the basis of an index depending on the number of users who receive an updated content. For this reason, the carrier FP1 can provide a service to a user (for example, U1) at low charge or for nothing.

### Another Embodiment

In the first to third embodiments, specific information may be an advertisement of a sponsor.

The name of specific information may not be recorded in a filtering server (in this case, the name is not presented to a user as a matter of course).

When a URL is presented such that not only the URL but also information such as an outline of a Web page are associated with specific information, these pieces of information may be simultaneously presented as described above.

In the specific information accumulating section (for example, 103), a keyword may not be registered simultaneously with the URL of specific information. In this case, a keyword extracted by the specific information accumulating section may be recorded by a method in which a system looks ahead to the information of a Web page indicated by a URL (more specifically, the Web page indicated by the URL is acquired) and handles a title portion in the obtained information as a keyword, a method in which the system handles, as a keyword, a character string frequently appearing in specific character strings included in a document to be acquired, or a method in which the system handles, as a keyword, a word determined as a noun after syntactic analysis.

The accumulated contents (for example, the configurations shown in FIGS. 3, 4, 5, 6, 7, 10, 11, and 14) in the components according to the first to third embodiments are not limited to the contents described above, as a matter of course.

In addition, in the third embodiment, the following process may be additionally performed. That is, in FIG. 13, inputting of a character string is accepted in conjunction with a URL set by a user, and the character string is accumulated in the difference acquiring section 309. When updating information is presented by the updated information presentation section 306, it is decided whether a difference includes a previously set character string. When the difference includes the character string, the updating information is presented to the user.

Regardless of the first and second embodiments, presentation of specific information to a user may be achieved by transmission of an electronic mail. More specifically, an electronic mail having the same content as that in FIG. 8 in the text portion may be transmitted to achieve presentation.

Even though the content of the URL of the specific information has been presented, when a predetermined period of time has elapsed, the value of recording information in the specific information recording section (for example, 107) may be changed into “unpresented” or “new”. It can be considered that the content is preferably presented again after a sufficient period of time has elapsed because the user probably forgets the content.

The electronic mail in the above description can also be replaced with another communication means.

In the first to third embodiments, although the present invention is applied to the Web, the present invention is not always applied to the Web.

In the present invention, communication through a network is not always necessary.

Therefore, the HTTP protocol can be replaced with another communication protocol, or a configuration which does not use the HTTP protocol can be employed.

For example, a configuration in which the function of the Web browser BR1 and the function of the filtering server (for example, 12) are mounted in one information processing apparatus can also be used.

Although the present invention is mainly realized as hardware in the above description, the present invention can also be realized as software.

The preferred embodiments of the present invention have been described above with reference to the accompanying drawings. However, the present invention is not limited to the related examples, as a matter of course. It is apparent to a person skilled in the art that various changes and modifications of the invention can be effected in the spirit and scope of the invention. It is naturally understood that the changes and modifications belong to the scope of the invention.

1. A filtering server which filters specific information desired by an information provider to be recognized by a user depending on a desire of the user and which transmits specific information which is not excluded by the filtering to the user, comprising:
a keyword acquiring section for acquiring a keyword input by the user;
a specific information accumulating section for accumulating a plurality of pieces of specific information;
a specific information retrieving section for retrieving specific information desired to be browsed by the user from the specific information accumulating section on the basis of the keyword acquired by the keyword acquiring section;
a specific information presentation recording section for storing the specific information retrieved by the specific information retrieving section and a recording information of the specific information;
a specific information presentation control section for extracting at least one piece of specific information from the pieces of specific information stored in the specific information presentation recording section depending on the recording information of the specific information presentation recording section; and
a specific information presentation section for presenting the specific information extracted by specific information presentation control section to the user.

2. The filtering server according to claim 1, wherein the recording information is presentation status information representing a status in which the specific information has been presented to the user until now, and
the specific information presentation control section extracts only specific information which has not been presented to the user until now.

3. The filtering server according to claim 2, wherein
the state of the presentation status information is forcibly changed into a state in which no specific information is presented when a predetermined period of time passes after specific information is previously presented to the user.

4. The filtering server according to claim 1, wherein
the recording information is content updating information representing whether the specific information is updated after the specific information is previously presented to the user and whether the specific information has been presented to the user until now, and
the specific information presentation control section extracts only the updated specific information and specific information which has not being presented to the user until now.

5. The filtering server according to claim 4, further comprising
a specific information updating detecting section for acquiring updating information of a Web page corresponding to specific information.

6. The filtering server according to claim 1, further comprising:
a setting screen presentation section for collecting specific information desired by a user through a setting Web page;
a difference acquiring section for acquiring a Web page at regular or irregular intervals on the basis of an input content collected by the setting screen presentation section, and extracting a difference between the Web page and a previously acquired Web page; and
an updating information presentation section for presenting the difference extracted by the difference extracting section to the user.

7. The filtering server according to claim 1, wherein
the specific information is at least one piece of information selected from the group consisting of the name of information provider, the URL of a Web page provided by the information provider, and an outline of the Web page.

8. The filtering server according to claim 1, further comprising
an user attribute information accumulating section for accumulating attribute information of a user, and wherein
the attribute information is at least one piece of information selected from a group consisting of a user ID, sex, age, occupation, habitation area, and mail address.

9. A filtering system which includes a communication terminal used by a user and also includes a filtering server which is connected to the communication terminal through a communication network and which filters specific information desired by an information provider to be recognized by the user depending on a desire of the user and which transmits specific information which is not excluded by the filtering to the user, wherein
the communication terminal comprises:
an input section for inputting a keyword; and
an output section for outputting a result obtained by the filtering, and
the filtering server comprises:
a keyword acquiring section for acquiring a keyword input by the user via the communication terminal;
a specific information accumulating section for accumulating a plurality of pieces of specific information;
a specific information retrieving section for retrieving specific information desired to be browsed by the user from the specific information accumulating section on the basis of the keyword acquired by the keyword acquiring section;
a specific information presentation recording section for storing the specific information retrieved by the specific information retrieving section and a recording information of the specific information;
a specific information presentation control section for extracting at least one piece of specific information from the pieces of specific information stored in the specific information presentation recording section depending on the recording information of the specific information presentation recording section; and
a specific information presentation section for presenting the specific information extracted by specific information presentation control section to the output section.

10. A filtering method which filters specific information desired by an information provider to be recognized by a user depending on a desire of the user and which transmits specific information which is not excluded by the filtering to the user, comprising:
the keyword acquiring step of acquiring a keyword input by the user;
the specific information retrieving step of retrieving specific information desired to be browsed by the user on the basis of the keyword acquired in the keyword acquiring step;
the specific information presentation recording step of storing the specific information retrieved in the specific information retrieving step and a recording information of the specific information;
the specific information presentation control step of extracting at least one piece of specific information from the specific information retrieved in the specific information retrieving step depending on the recording information of the specific information retrieved in the specific information retrieving step; and
the specific information presentation step of presenting the specific information extracted in the specific information presentation control step to the user.

11. The filtering method according to. Claim 10, wherein
the recording information is presentation status information representing a status in which the specific information has been presented to the user until now, and
in the specific information presentation control step, only specific information which has not been presented to the user until now is extracted.

12. The filtering method according to claim 11, wherein
the state of the presentation status information is forcibly changed into a state in which no specific information is presented when a predetermined period of time passes after specific information is previously presented to the user.

13. The filtering method according to claim 10, wherein
the recording information is content updating information representing whether the specific information is updated after the specific information is previously presented to the user and whether the specific information has been presented to the user until now, and
in the specific information presentation control step, only the updated specific information and specific information which has not being presented to the user until now is extracted.

14. The filtering method according to claim 13, further comprising
the specific information updating detecting step of acquiring updating information of a Web page corresponding to specific information.

15. The filtering method according to claim 10, further comprising:
the setting screen presentation step of collecting specific information desired by a user through a setting Web page;
the difference acquiring step of acquiring a Web page at regular or irregular intervals on the basis of an input content collected in the setting screen presentation step, and extracting a difference between the Web page and a previously acquired Web page; and
the updating information presentation step of presenting the difference extracted in the difference extracting step to the user.
